(19) United States
(12) Patent Application Publication
(10) Pub. No.: US 2026/0266208 A1
(43) Pub. Date: Sep. 10, 2026

(54) VALV E ASSEMBLY FOR INTERNAL COMBUSTION ENGINE SYSTEM WITH TURBOMACHINERY

(71) Applicant: Cummins Emission Solutions, Inc., Columbus, IN (US)

(72) Inventors: Samuel Johnson, East Wenatchee, WA (US); Chetan Kishorrao Chawane, Pune (IN); Donald Edward Willey, Huddersfield (GB); Atif Mahmood, Huddersfield (GB)

(73) Assignee: Cummins Emission Solutions, Inc., Columbus, IN (US)

(21) Appl. No.: 18/869,489

(22) PCT Filed: May 25, 2023
(86) PCT No.: PCT/US2023/023512

§ 371 Date: Nov. 26, 2024

(30) Foreign Application Priority Data
May 30, 2022 (IN) 202241030870

(51) Int. Cl. F01N 3/20; F01N 3/28

(52) U.S. Cl. CPC F01N 3/2066; F01N 3/208; F01N 3/2882; F01N 3/2892; F01N 2340/02; F01N 2340/06; F01N 2610/02; F01N 2610/1453

(57) ABSTRACT

An internal combustion engine system includes a turbomachine, an exhaust conduit, a first dosing module, and a valve assembly. The exhaust conduit is coupled to the turbomachine and is configured to receive exhaust from the turbomachine. The exhaust conduit has a conduit internal diameter The first dosing module is positioned along the exhaust conduit and is configured to selectively dose reductant into the exhaust within the exhaust conduit. The valve assembly is selectively actuatable between at least (i) a first position that allows the exhaust to flow at a first flow rate, and (ii) a second position that allows the exhaust to flow at a second flow rate. A first valve assembly distance between the valve assembly and the first dosing module is less than or equal to 3 times the conduit internal diameter.

### CROSS-REFERENCE TO RELATED APPLICATION

The present application is a National Stage of PCT Application No. PCT/US2023/023512, filed on May 25, 2023, which claims the benefit of and priority to Indian Provisional Application No. 202241030870, filed on May 30, 2022. The contents of these applications are incorporated herein by reference in their entirety and for all purposes.

### TECHNICAL FIELD

The present disclosure relates generally to an aftertreatment system for an internal combustion engine.

### BACKGROUND

It is desirable to treat exhaust produced by combustion of fuel in an internal combustion engine. The exhaust can be treated using an aftertreatment system. One approach that can be implemented in an aftertreatment system is to dose the exhaust with a reductant and pass the exhaust and reductant through a catalyst member.

### SUMMARY

In one embodiment, an internal combustion engine system includes a turbomachine, an exhaust conduit, a first dosing module, and a valve assembly. The exhaust conduit is coupled to the turbomachine and is configured to receive exhaust from the turbomachine. The exhaust conduit has a conduit internal diameter. The first dosing module is positioned along the exhaust conduit and is configured to selectively dose reductant into the exhaust within the exhaust conduit. The valve assembly is positioned within the exhaust conduit. The valve assembly is selectively actuatable between at least (i) a first position that allows the exhaust to flow at a first flow rate through the exhaust conduit, and (ii) a second position that allows the exhaust to flow at a second flow rate through the exhaust conduit. A first valve assembly distance between the valve assembly and the first dosing module is less than or equal to 3 times the conduit internal diameter.

In another embodiment, an internal combustion engine system includes a turbomachine, an exhaust conduit, a first dosing module, and a valve assembly. The exhaust conduit is coupled to the turbomachine and is configured to receive exhaust from the turbomachine. The first dosing module is positioned along the exhaust conduit and is configured to selectively dose reductant into the exhaust within the exhaust conduit. The second dosing module configured to selectively dose reductant into the exhaust within the exhaust conduit. The valve assembly is positioned within the exhaust conduit downstream of the turbomachine and upstream of the first dosing module. The valve assembly is selectively actuatable between at least (i) a first position that allows the exhaust to flow at a first flow rate through the exhaust conduit, and (ii) a second position that allows the exhaust to flow at a second flow rate through the exhaust conduit.

In another embodiment, an internal combustion engine system includes a turbomachine, an exhaust conduit, a first dosing module, and a valve assembly. The exhaust conduit is coupled to the turbocharger and is configured to receive exhaust from the turbomachine. The first dosing module is positioned along the exhaust conduit and is configured to selectively dose reductant into the exhaust within the exhaust conduit. The valve assembly positioned within the exhaust conduit downstream of the first dosing module. The valve assembly being selectively actuatable between at least (i) a first position that allows the exhaust to flow at a first flow rate through the exhaust conduit, and (ii) a second position that allows the exhaust to flow at a second flow rate through the exhaust conduit.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a cross-sectional view of a portion of an example aftertreatment system;

FIG. 2 is a cross-sectional view of a portion of another example aftertreatment system;

FIG. 3 is a cross-sectional view of a portion of yet another example aftertreatment system;

FIG. 4 is a perspective view of another portion of an example aftertreatment system;

FIG. 5 is a first side view of a portion of an example aftertreatment system;

FIG. 6 is a second side view of a portion of an example aftertreatment system;

FIG. 7 is a third side view of a portion of an example aftertreatment system;

FIG. 8 is a fourth side view of a portion of an example aftertreatment system;

FIG. 9 is a top view of an example valve plate for an example aftertreatment system;

FIG. 10 is a front view of the valve plate of FIG. 9;

FIG. 11 is a side view of an example valve assembly for an example aftertreatment system;

FIG. 12 is a side view of another example valve assembly for an example aftertreatment system; and

FIG. 13 is a side view of a portion of an example turbocharger for an example aftertreatment system.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Embodiments described herein relate generally to systems, methods, and apparatuses, and for a valve assembly for internal combustion engine system with a turbomachine, such as a turbocharger, a power turbine, a turbo-compound, etc. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

To meet emission regulations that require an engine system to reduce nitrogen oxides (NOx) earlier (i.e., at a shorted time from cold start) an aftertreatment system may include a fluid system for injecting reductant into exhaust from an engine. A dual dosing system may be used to provide reductant at two different locations in the aftertreatment system. In some aftertreatment systems, a valve is used to increase back pressure thereby causing an increase in temperature to facilitate NOx reduction. More specifically, valves may be used for engine braking and thermal management. Thermal management may include increasing a “pumping work” value of the engine by restricting exhaust flow by the valve, thereby raising exhaust gas temperatures for the aftertreatment system. As used herein the “pumping work” or a “pumping work value” refers to an amount of work done by the engine during an intake stroke and/or an exhaust stroke of an engine cycle.

Implementations herein are direction to an aftertreatment system for an engine system that includes a turbomachine, such as a turbocharger, a power turbine, a turbo-compound, etc. The aftertreatment system includes two dosing modules and a valve assembly. The valve assembly may be located between the turbomachine and one of the dosing modules, between the two dosing modules, or proximate one of the dosing modules and upstream of the other dosing module. The valve assembly may be controlled so as to cause mixing of reductant from the dosing modules with the exhaust gas. The valve assembly may also create backpressure to assist with diffusion upstream of the valve assembly, thereby promoting mixing of the reductant and the exhaust gas. The implementations herein further include methods for operating the valve and the dual dosing system to achieve a desired NOx reduction.

Additional implementations herein are directed to an aftertreatment system for an engine system that includes a turbomachine. The aftertreatment system includes one dosing module and a valve assembly upstream of the first catalyst. The valve assembly may be located between the turbomachine and the dosing module, or proximate the dosing module. The valve assembly may be controlled so as to cause mixing of reductant from the dosing modules with the exhaust gas. The valve assembly may also create backpressure to assist with diffusion upstream of the valve assembly, thereby promoting mixing of the reductant and the exhaust gas. The implementations herein further include methods for operating the valve and the dual dosing system to achieve a desired NOx reduction.

### II. Overview of Example Aftertreatment Systems

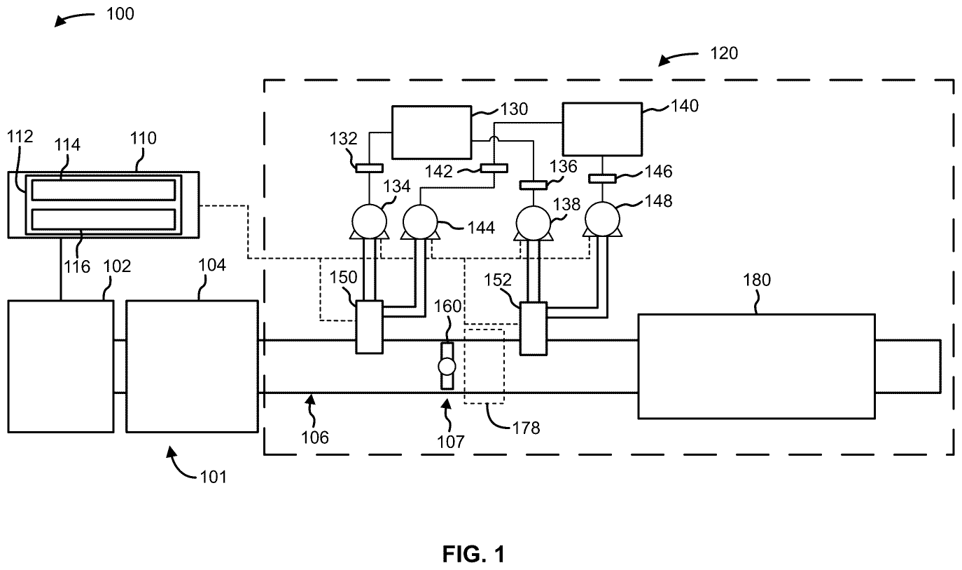

FIGS. 1-3 depict a system 100 (e.g., a vehicle system, etc.) including an internal combustion engine system 101, a controller 110, and an aftertreatment system 120 (e.g., treatment system, etc.). The internal combustion engine system 101 includes an internal combustion engine 102 (e.g., diesel internal combustion engine, gasoline internal combustion engine, hybrid internal combustion engine, propane internal combustion engine, dual-fuel internal combustion engine, etc.) and a turbomachine 104 (e.g., a turbocharger, a power turbine, a turbo-compound, etc.). One or more of the components of the internal combustion engine system 101 may be communicable with the controller 110. The aftertreatment system 120 is configured to treat exhaust produced by the internal combustion engine. As is explained in more detail herein, the aftertreatment system 120 is configured to facilitate treatment of the exhaust. The treatment may facilitate reduction of emission of undesirable components (e.g., nitrogen oxides (NOX), Sulfur Oxide (SOx), etc.) in the exhaust. The treatment may also or instead facilitate conversion of various oxidation components (e.g., carbon monoxide (CO), hydrocarbons, etc.) of the exhaust into other components (e.g., CO₂, water vapor, etc.). The treatment may also or instead facilitate removal of particulates (e.g., soot, particulate matter, etc.) from the exhaust.

The aftertreatment system 120 includes an exhaust conduit system 105 (e.g., line system, pipe system, etc.). The exhaust conduit system 105 is configured to facilitate routing of the exhaust produced by the internal combustion engine 102 throughout the aftertreatment system 120 and to atmosphere (e.g., ambient environment, etc.). The exhaust conduit system 105 has an exhaust conduit internal diameter and an exhaust conduit external diameter.

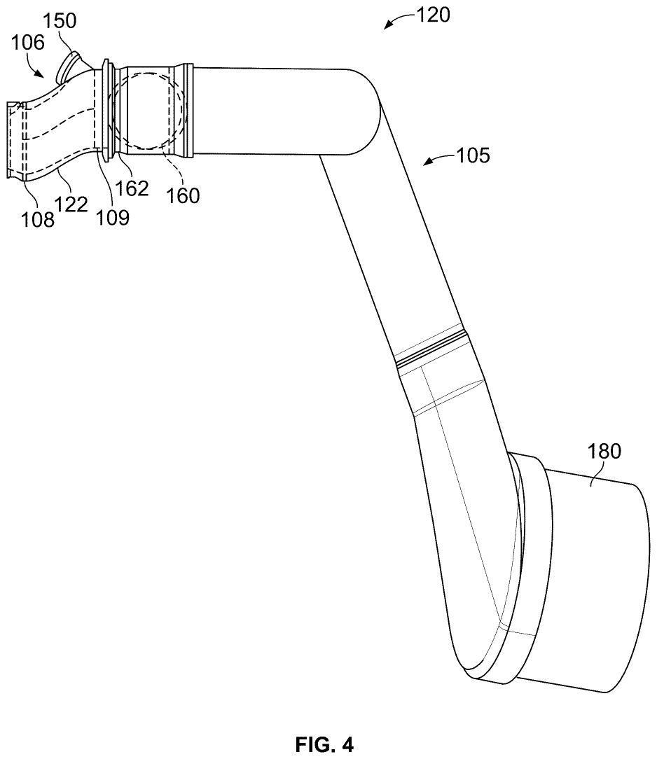

The exhaust conduit system 105 includes an inlet conduit 106 (e.g., line, pipe, etc.). The inlet conduit 106 is in fluid communication with an upstream component (e.g., header on the internal combustion engine 102, diffuser on the internal combustion engine 102, the internal combustion engine 102, a header on the turbomachine 104, diffuser on the turbomachine 104, the turbomachine 104, etc.) and is configured to receive exhaust from the upstream component. In some embodiments, the inlet conduit 106 is coupled (e.g., attached, fixed, welded, fastened, riveted, adhesively attached, bonded, pinned, etc.) to the upstream component. In other embodiments, the inlet conduit 106 is integrally formed with the upstream component. The structure of the inlet conduit 106 is described in more detail herein with respect to FIG. 4.

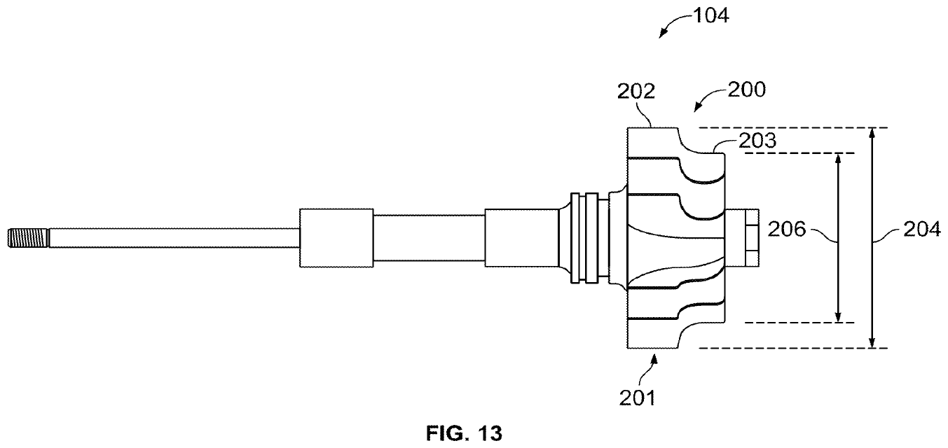

In some embodiments and as shown in FIG. 13, the turbomachine 104 is or includes a turbocharger. In these embodiments, the turbocharger includes a turbine wheel 200 having a plurality of fins 201. Each of the plurality of fins 201 includes an inducer 202 and an exducer 203. Relative to a direction of gas flow through the plurality of fins 201, the inducer 202 is an upstream portion of a given fin where the gas flow first contacts the fin, and in turn, the gas flow contacts the downstream exducer 203 last. The inducer 202 has an inducer diameter 204. The exducer 203 has an exducer diameter 206. The turbocharger is configured to receive exhaust from the engine 102 to spin a turbine wheel 200. The turbocharger may include or be coupled to a compressor, such that, when the turbine wheel 200 spins, the turbocharger causes the compressor to compress air within an intake of the engine 102.

As briefly described above, in some embodiments, the system 100 includes the turbomachine 104. The system 100 may include, in addition, a second turbomachine. In some embodiments, the turbomachine 104 is or includes a power turbine. In these embodiments, the power turbine is configured to receive exhaust from the engine 102 to spin a turbine of the power turbine. In some embodiments, the power turbine may be coupled to an electric machine, such as a motor/generator, such that, when the turbine of the power turbine spins, the power turbine causes the electric machine to generate electricity. In some embodiments, the power turbine may be coupled to a driveshaft or other component of the system 100, such as a transmission. In this way, the power turbine provides mechanical power to the driveshaft, the transmission, etc.

In other embodiments, the turbomachine is a turbo-compound system. The turbo-compound system is configured to recover energy from the exhaust and use the recovered energy to provide mechanical power to an output shaft of the engine 102 (e.g., a crankshaft, etc.). For example, the turbo-compound system includes a turbine configured to receive exhaust from the engine 102 thereby spinning the turbine. The turbo-compound system is configured to deliver the mechanical work of the spinning turbine to a crankshaft of the engine 102.

It should be understood that, in any of the embodiments described herein, the turbomachine includes at least one of a turbocharger, a power turbine, a turbo-compound system, or other suitable turbo device.

The exhaust conduit system 105 also includes an introduction conduit 107 (e.g., decomposition housing, decomposition reactor, decomposition chamber, reactor pipe, decomposition tube, reactor tube, etc.). The introduction conduit 107 is in fluid communication with the inlet conduit 106 and is configured to receive exhaust from the inlet conduit 106. In various embodiments, the introduction conduit 107 is coupled to the inlet conduit 106. For example, the introduction conduit 107 may be fastened (e.g., using a band, using bolts, using twist-lock fasteners, threaded, etc.), welded, riveted, or otherwise attached to the inlet conduit 106. In other embodiments, the introduction conduit 107 is integrally formed with the inlet conduit 106. As utilized herein, the terms “fastened,” “fastening,” and the like describe attachment (e.g., joining, etc.) of two structures in such a way that detachment (e.g., separation, etc.) of the two structures remains possible while “fastened” or after the “fastening” is completed, without destroying or damaging either or both of the two structures. In some embodiments, the inlet conduit 106 is the introduction conduit 107 (e.g., only the inlet conduit 106 is included in the exhaust conduit system 105 and the inlet conduit 106 functions as both the inlet conduit 106 and the introduction conduit 107).

The aftertreatment system 120 also includes a treatment fluid delivery system 122. As is explained in more detail herein, the treatment fluid delivery system 122 is configured to facilitate the introduction of a treatment fluid, such as a reductant (e.g., diesel exhaust fluid (DEF), Adblue®, a urea-water solution (UWS), an aqueous urea solution, AUS32, etc.) into the exhaust. When the reductant is introduced into the exhaust, reduction of emission of undesirable components in the exhaust may be facilitated.

The treatment fluid delivery system 122 includes a first dosing module 150 (e.g., doser, reductant doser, etc.) and a second dosing module 152. The first dosing module 150 and the second dosing module 152 are each configured to facilitate passage of the treatment fluid through the introduction conduit 107 and into the introduction conduit 107. The first dosing module 150 and the second dosing module 152 may include an insulator interposed between a portion of the first dosing module 150 and/or the second dosing module 152 and the portion of the introduction conduit 107 on which the first dosing module 150 and/or the second dosing module 152 is mounted. In various embodiments, the first dosing module 150 and the second dosing module 152 are coupled to the introduction conduit 107.

The treatment fluid delivery system 122 includes a treatment fluid source 130 (e.g., reductant tank, etc.). The treatment fluid source 130 is configured to contain the treatment fluid. The treatment fluid source 130 is in fluid communication with the first dosing module 150 and the second dosing module 152 and configured to provide the treatment fluid to the first dosing module 150 and the second dosing module 152. The treatment fluid source 130 may include multiple treatment fluid sources 130 (e.g., multiple tanks connected in series or in parallel, etc.). The treatment fluid source 130 may be, for example, a diesel exhaust fluid tank containing Adblue® or a fuel tank containing fuel.

The treatment fluid delivery system 122 also includes a first treatment fluid pump 134 and a second treatment fluid pump 138 (e.g., supply unit, etc.). The first treatment fluid pump 134 is in fluid communication with the treatment fluid source 130 and the first dosing module 150 and configured to receive the treatment fluid from the treatment fluid source 130 and to provide the treatment fluid to the first dosing module 150. The first treatment fluid pump 134 is used to pressurize the treatment fluid from the treatment fluid source 130 for delivery to the first dosing module 150. In some embodiments, the first treatment fluid pump 134 is pressure controlled. In some embodiments, the first treatment fluid pump 134 is coupled to a chassis of a vehicle associated with the aftertreatment system 120. The second treatment fluid pump 138 is in fluid communication with the treatment fluid source 130 and the second dosing module 152 and configured to receive the treatment fluid from the treatment fluid source 130 and to provide the treatment fluid to the second dosing module 152. The second treatment fluid pump 138 is used to pressurize the treatment fluid from the treatment fluid source 130 for delivery to the second dosing module 152. In some embodiments, the second treatment fluid pump 138 is pressure controlled. In some embodiments, the second treatment fluid pump 138 is coupled to a chassis of a vehicle associated with the aftertreatment system 120.

In other embodiments, the treatment fluid delivery system 122 includes only the first treatment fluid pump 134. In these embodiments, the first treatment fluid pump is in fluid communication with the treatment fluid source 130, the first dosing module 150, and the second dosing module 152 and configured to receive the treatment fluid from the treatment fluid source 130 and to provide the treatment fluid to the first dosing module 150 and the second dosing module 150. In some embodiments, the first treatment fluid pump 134 may be in fluid communication with the first dosing module 150 and the second dosing module 152 in parallel (e.g., where the first treatment fluid pump 134 is in direct fluid communication with both the first dosing module 150 and the second dosing module 152) or in series (e.g., where the first treatment fluid pump 134 is in direct fluid communication with the first dosing module 150 and the first dosing module is in fluid communication with the second dosing module 152 such that the treatment fluid flows from the first dosing module 150 to the second dosing module 152).

In some embodiments, the treatment fluid delivery system 122 also includes a first treatment fluid filter 132 and a second treatment fluid filter 136. The first treatment fluid filter 132 is in fluid communication with the treatment fluid source 130 and the first treatment fluid pump 134 and is configured to receive the treatment fluid from the treatment fluid source 130 and to provide the treatment fluid to the first treatment fluid pump 134. The first treatment fluid filter 132 filters the treatment fluid prior to the treatment fluid being provided to internal components of the first treatment fluid pump 134. For example, the first treatment fluid filter 132 may inhibit or prevent the transmission of solids to the internal components of the first treatment fluid pump 134. In this way, the first treatment fluid filter 132 may facilitate prolonged desirable operation of the first treatment fluid pump 134. The second treatment fluid filter 136 is in fluid communication with the treatment fluid source 130 and the second treatment fluid pump 138 and is configured to receive the treatment fluid from the treatment fluid source 130 and to provide the treatment fluid to the second treatment fluid pump 138. The second treatment fluid filter 136 filters the treatment fluid prior to the treatment fluid being provided to internal components of the second treatment fluid pump 138. For example, the second treatment fluid filter 136 may inhibit or prevent the transmission of solids to the internal components of the second treatment fluid pump 138. In this way, the second treatment fluid filter 136 may facilitate prolonged desirable operation of the second treatment fluid pump 138.

In some embodiments, the first dosing module 150 includes at least one injector (not shown) (e.g., insertion device, etc.). The injector may be fluidly coupled to the first treatment fluid pump 134 and configured to receive the treatment fluid from the first treatment fluid pump 134. The injector is configured to dose (e.g., inject, insert, etc.) the treatment fluid received by the first dosing module 150 into the exhaust within the introduction conduit 107.

In some embodiments, the second dosing module 152 includes at least one injector (not shown) (e.g., insertion device, etc.). The injector may be fluidly coupled to the second treatment fluid pump 138 and configured to receive the treatment fluid from the second treatment fluid pump 138. The injector is configured to dose (e.g., inject, insert, etc.) the treatment fluid received by the second dosing module 152 into the exhaust within the introduction conduit 107.

In some embodiments, the treatment fluid delivery system 122 also includes an air source 140 (e.g., air intake, etc.), a first air pump 144, and a second air pump 148. The first air pump 144 is fluidly coupled to the air source 140 and is configured to receive air from the air source 140. The first air pump 144 is fluidly coupled to the first dosing module 150 and is configured to provide the air to the first dosing module 150. In some applications, the first dosing module 150 is configured to mix the air and the treatment fluid into an air-treatment fluid mixture and to provide the air-treatment fluid mixture to the injector (e.g., for dosing into the exhaust within the introduction conduit 107, etc.). The injector is fluidly coupled to the first air pump 144 and configured to receive the air from the first air pump 144. The injector is configured to dose the air-treatment fluid mixture into the exhaust within the introduction conduit 107. In some of these embodiments, the treatment fluid delivery system 122 also includes a first air filter 142. The first air filter 142 is fluidly coupled to the air source 140 and the first air pump 144 and is configured to receive the air from the air source 140 and to provide the air to the first air pump 144. The first air filter 142 is configured to filter the air prior to the air being provided to the first air pump 144.

The second air pump 148 is fluidly coupled to the air source 140 and is configured to receive air from the air source 140. The second air pump 148 is fluidly coupled to the second dosing module 152 and is configured to provide the air to the second dosing module 152. In some applications, the second dosing module 152 is configured to mix the air and the treatment fluid into an air-treatment fluid mixture and to provide the air-treatment fluid mixture to the injector (e.g., for dosing into the exhaust within the introduction conduit 107, etc.). The injector is fluidly coupled to the second air pump 148 and configured to receive the air from the second air pump 148. The injector is configured to dose the air-treatment fluid mixture into the exhaust within the introduction conduit 107. In some of these embodiments, the treatment fluid delivery system 122 also includes a second air filter 146. The second air filter 146is fluidly coupled to the air source 140 and the second air pump 148 and is configured to receive the air from the air source 140 and to provide the air to the second air pump 148. The second air filter 146 is configured to filter the air prior to the air being provided to the second air pump 148.

In other embodiments, the treatment fluid delivery system 122 does not include the first air pump 144, the second air pump 148, and/or the air source 140. In such embodiments, the first dosing module 150 and/or the second dosing module 152 is/are not configured to mix the treatment fluid with the air.

In various embodiments, the first dosing module 150 and/or the second dosing module 152 is/are configured to receive air and fluid, and doses the air fluid mixture into the introduction conduit 107. In various embodiments, the first dosing module 150 and/or the second dosing module 152 is/are configured to receive treatment fluid (and not air), and dose the treatment fluid into the introduction conduit 107. In various embodiments, the first dosing module 150 and/or the second dosing module 152 is/are configured to receive treatment fluid, and dose the treatment fluid into the introduction conduit 107. In various embodiments, the first dosing module 150 and/or the second dosing module 152 is/are configured to receive air and treatment fluid, and dose the air-treatment fluid mixture into the introduction conduit 107. In various embodiments, the first dosing module 150 and/or the second dosing module 152 is/are configured to provide the treatment fluid and/or the air-treatment fluid mixture in a spray cone. The spray cone of the fluid provided by the first dosing module 150 and/or the second dosing module 152 may define one or more diameters including a maximum spray cone diameter.

In some embodiments, the first dosing module 150 positioned along the exhaust conduit system 105. As described above, the first dosing module 150 is configured to selectively dose reductant into the exhaust within the exhaust conduit system 105. More specifically, in some embodiments, the first dosing module 150 is a close coupled dosing module. That is, the first dosing module 150 is coupled to the exhaust conduit system 105 proximate an outlet of the internal combustion engine system 101 (e.g., proximate an outlet of the engine 102 and/or proximate an outlet of the turbomachine 104). For example, the first dosing module 150 may be coupled to the exhaust conduit system 105 downstream from the internal combustion engine 102 and/or the turbomachine 104. For example, a distance between the first dosing module 150 and the turbomachine 104 is between 0 and 10 exducer diameters, where the exducer diameter is a diameter of a turbine wheel exit plane.

In some embodiments, the second dosing module 152 is positioned along the exhaust conduit 105 and downstream of the first dosing module 150. As described above, the second dosing module 152 is configured to selectively dose reductant into the exhaust within the exhaust conduit system 105. A distance between the first dosing module 150 and the second dosing module 152 is between 0.5 and 10 meters.

The first dosing module 150, the second dosing module 152, the first treatment fluid pump 134, the second treatment fluid pump 138, the first air pump 144, and the second air pump 148 are communicable with the controller 110. The controller 110 is configured to control the first dosing module 150 and/or the second dosing module 152 to dose the treatment fluid or the air-treatment fluid mixture into the introduction conduit 107. The controller 110 may also be configured to control the first treatment fluid pump 134, the second treatment fluid pump 138, the first air pump 144, and/or the second air pump 148 in order to control the treatment fluid or the air-treatment fluid mixture that is dosed into the introduction conduit 107.

The controller 110 includes a processing circuit 112. The processing circuit 112 includes a processor 114 and a memory 116. The processor 114 may include a microprocessor, an application-specific integrated circuit (ASIC), a field-programmable gate array (FPGA), etc., or combinations thereof. The memory 116 may include, but is not limited to, electronic, optical, magnetic, or any other storage or transmission device capable of providing a processor, ASIC, FPGA, etc. with program instructions. This memory 116 may include a memory chip, Electrically Erasable Programmable Read-Only Memory (EEPROM), Erasable Programmable Read Only Memory (EPROM), flash memory, or any other suitable memory from which the controller 110 can read instructions. The instructions may include code from any suitable programming language. The memory 116 may include various modules that include instructions which are configured to be implemented by the processor 114.

In various embodiments, the controller 110 is configured to communicate with a central controller (e.g., engine control unit (ECU), engine control module (ECM), etc.) of the engine 102. In some embodiments, the central controller and the controller 110 are integrated into a single controller, as shown in FIGS. 1-3.

In some embodiments, the controller 110 is communicable with a display device (e.g., screen, monitor, touch screen, heads up display (HUD), indicator light, etc.). The display device may be configured to change state in response to receiving information from the controller 110. For example, the display device may be configured to change between a static state and an alarm state based on a communication from the controller 110. By changing state, the display device may provide an indication to a user of a status of one or more components of the aftertreatment system 120, such as the treatment fluid delivery system 122.

The aftertreatment system 120 also includes a valve assembly 160 (e.g., an aftertreatment valve, an exhaust valve, etc.). The valve assembly 160 is positioned within the introduction conduit 107. In some embodiments, and as shown in FIG. 1, the valve assembly 160 is positioned downstream of the first dosing module 150 and upstream of the second dosing module 152. In these embodiments, a distance between the valve assembly 160 and the first dosing module 150 is between 0 and 10 conduit internal diameters, and a distance between the valve assembly 160 and the second dosing module 152 is between 0 and 10 meters. In some embodiments, a ratio of the distance between the first dosing module 150 and the turbomachine 104, and the distance between the valve assembly 160 and the first dosing module 150, is between 0 and 10 conduit internal diameters.

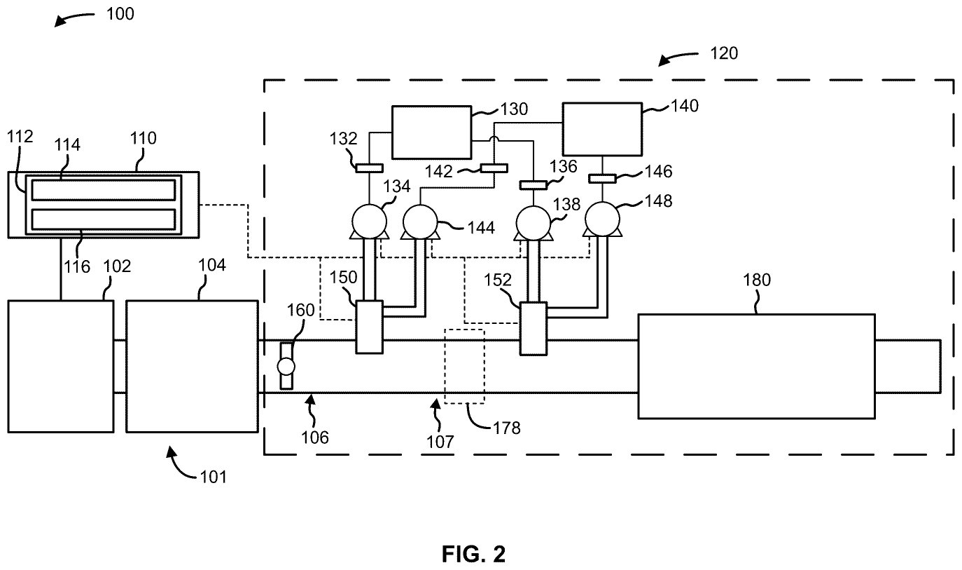

In some embodiments, and as shown in FIG. 2, the valve assembly 160 is positioned upstream of the first dosing module 150 and downstream of the turbomachine 104. In these embodiments, a distance between the valve assembly 160 and the first dosing module 150 is between 1 and 10 conduit internal diameters, and a distance between the valve assembly 160 and the turbomachine 104 is between 1 and 10 conduit internal diameters. In some embodiments, a ratio of the distance between the first dosing module 150 and the turbomachine 104, and the distance between the valve assembly 160 and the first dosing module 150, is between 1 and 10 conduit internal diameters.

In other embodiments, and as shown in FIG. 2, the valve assembly 160 is positioned upstream of the first dosing module 150 and downstream of the turbomachine 104. In these embodiments, a distance between the valve assembly 160 and the first dosing module 150 is less than the maximum spray cone diameter such that the spray will impinge upon the valve assembly 160, and a distance between the valve assembly 160 and the turbomachine 104 is between 0 and 2 conduit internal diameters. In some embodiments, a ratio of the distance between the first dosing module 150 and the turbomachine 104, and the distance between the valve assembly 160 and the first dosing module 150, is between 1 and 10 conduit internal diameters. In other embodiments, the ration of the distance between the first dosing module 150 and the turbomachine 104, and the distance between the valve assembly 160 and the first dosing module 150, is between 0.1 and 10, or more specifically between 0.5 and 2.

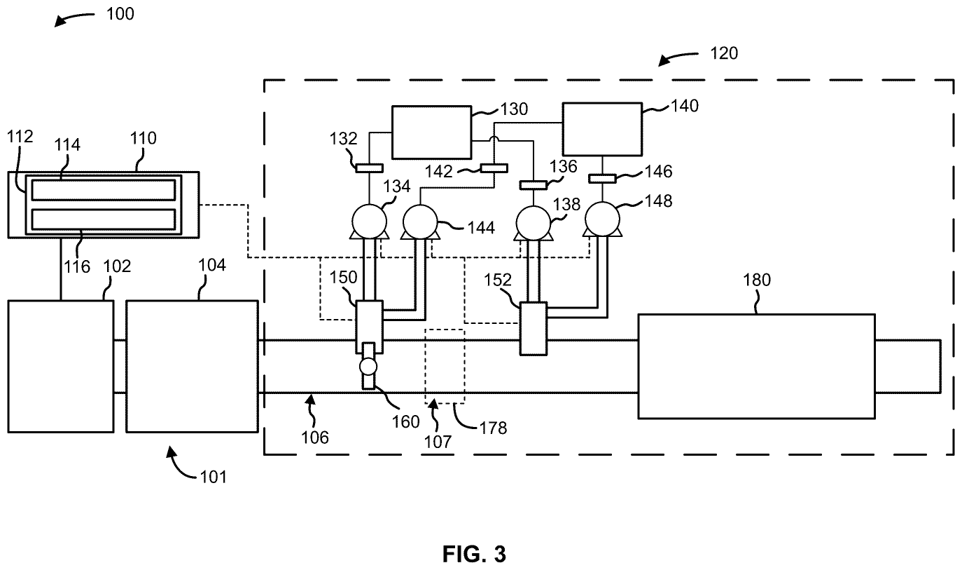

In some embodiments, and as shown in FIG. 3, the valve assembly 160 is positioned proximate the first dosing module 150. In these embodiments, a distance between the valve assembly 160 and the first dosing module 150 is between 0 and 3 conduit internal diameters.

The valve assembly 160 receives exhaust from the internal combustion engine system 101 (e.g., the engine 102 and/or the turbomachine 104—via the inlet conduit 106 and/or the introduction conduit 107, etc.). In the embodiments shown in FIGS. 1 and 3, the valve assembly 160 also receives the treatment fluid or the air-treatment fluid mixture received from the first dosing module 150. The valve assembly 160 is configured to selectively actuate between a plurality of positions (e.g., between an open position and a closed position). Each position of the valve assembly 160 may correspond to a particular flow rate of the exhaust flowing through the exhaust conduit system 105. For example, a first position of the valve assembly 160 may allow the exhaust to flow at a first flow rate through the exhaust conduit system 105, and a second position of the valve assembly 160 may allow the exhaust to flow at a second flow rate through the exhaust conduit system 105.

The valve assembly 160 includes a valve actuator 162 and a valve plate 164. The valve actuator 162 may be configured to selectively actuate the valve plate between the plurality of positions. In some embodiments, the valve actuator 162 is communicable with the controller 110. In these embodiments, the controller 110 is configured to operate the valve actuator 162 such that the controller 110 is operable to actuate the valve assembly so as to move between the plurality of positions. In an example embodiment, the controller 110 may operate the valve assembly 160 based on the operation of the first dosing module 150 and/or based on the operation of the second dosing module 152. An example of a control method may include controlling the first dosing module 150 and/or the second dosing module 152 to reduce the amount of dosing during a thermal management event and when the valve assembly 160 is impeding the flow of the exhaust through the exhaust conduit system 105. During this condition, the valve assembly 160 may be subject to high amounts of treatment fluid impingement, combined with the increased recirculation downstream of the valve assembly 160, creating a condition for deposit of the treatment fluid. By reducing the amount of treatment fluid dosing during a thermal management event, the deposit risk is advantageously reduced. In some embodiments, the controller 110 may control the valve assembly 160 to be actuated such that valve assembly 160 facilitates mixing of the treatment fluid with the exhaust in the exhaust conduit system 105 due to increased flow turbulence downstream of the valve plate 164. In some embodiments, the controller may control the valve assembly 160 to be actuated such that the valve assembly 160 increases fluid shear stress at the wall(s) of the exhaust conduit system 105. For example, as the valve assembly 160 actuates to decrease an effective flow area around the valve plate 164, a change in pressure across the plate will increase, thereby increasing a velocity of the exhaust around the valve plate 164.

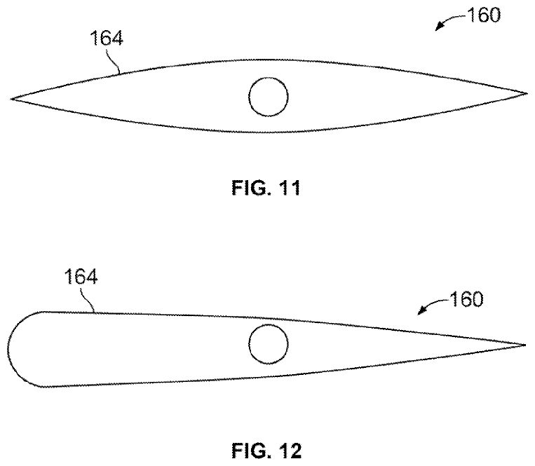

In some embodiments, the profile of the valve plate 164 may be aerodynamically shaped such that the valve plate 164 provides an improved or adjusted profile to reduce recirculation & stagnation zones created by the valve assembly 160. In the embodiment shown in FIG. 11, the valve plate 164 has a first shape that includes a leading edge and a tail edge that are both thinner than a center portion of the valve plate 164. The first shape causes the exhaust to flow past the valve assembly 160 with first flow characteristics (e.g., flow rate, turbulence, etc.). In the embodiment shown in FIG. 12, the valve plate 164 has a second shape that includes a leading edge that is thicker than a center portion of the valve plate 164, and the center portion of the valve plate 164 is thicker than a tail edge of the valve plate 164. The second shape causes the exhaust to flow past the valve assembly 160 with second flow characteristics (e.g., flow rate, turbulence, etc.). It should be understood that the shapes shown in FIGS. 11 and 12 are examples only, and the valve plate 164 may a different shape. All such variations are intended to fall within the scope of the present disclosure.

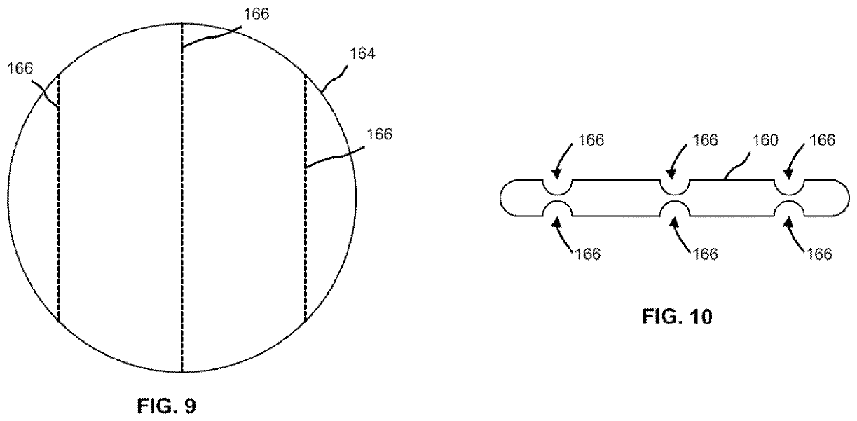

In some embodiments, the valve plate 164 may include one or more features to direct the exhaust to flow to these zones to disrupt the zone or sweep it clean of any treatment fluid trapped in these zones. In an example embodiment the valve plate 164 includes simplistic flow guide vanes that send some flow downstream of the valve plate 164. In another example embodiment, the valve plate 164 comprises one or more flow vanes 166 configured to direct the flow direction of the exhaust as the exhaust passes over the valve plate 164. The vanes 166 may be recessed in or protrude from the valve plate 164. As shown in FIGS. 9 and 10, the vanes 166 are oriented axially with the exhaust flow. That is the vanes 166 point in an upstream/downstream direction such that the vanes 166 act as vortex generators to disrupt a boundary layer over the valve plate 164 and/or reduce a stagnation/recirculation zone downstream of a trailing edge of the valve plate 164. In an example embodiment, the aerodynamic profile of the valve plate 164 advantageously reduces wake zones and flow detachment instigated by the valve plate 164.

The valve plate 164 has a valve plate diameter. The valve plate diameter may be equal to an inner diameter of the exhaust conduit system 105 at the location of the valve assembly 160. That is the valve plate diameter is the same as the exhaust conduit system 105 in which the valve assembly 160 is installed. The valve plate diameter advantageously reduces any step changes or transitions that can cause flow detachment, which may cause treatment fluid deposit, or restrict exhaust flow, thus increasing engine breathing efficiency.

In some embodiments, a portion of the exhaust conduit system 105 at the valve assembly 160 may be structured to reduce gaps and discontinuities between the exhaust conduit system 105 and the valve assembly 160. Such gaps or discontinuities may trap treatment fluid as the treatment fluid is provided into the exhaust conduit system 105.

In some embodiments, the valve plate 164 may have a relatively smooth surface finish. For example, the valve plate 164 may have a surface finish that is between 0.010 micrometers (μm) average surface roughness (Ra) and 15 μm Ra, inclusive or between 0.1 μm Ra and 125 μm Ra. The reduced surface roughness of the valve plate 164 may be achieved by secondary machining, polishing, lapping, 3D printing, or changing casting methods/specifications. The reduced surface roughness of the valve plate 164 may advantageously decrease the propensity for treatment fluid to adhere to the valve plate 164 to mitigate deposit of the treatment fluid. Additionally and/or alternatively the reduced surface roughness of the valve plate 164 may advantageously reduce a thickness of a flow boundary layer near walls of the valve plate 164 to mitigate deposit of the treatment fluid.

In some embodiments, the materials used to create the components of the valve assembly 160 (e.g., the valve plate 164, bearings, bushings, seals, etc.) may be in-line with mixer material specifications that are robust to resisting corrosion in a treatment fluid/ammonia rich environment. For example, the materials may include various grades of stainless steel, non-aluminum, and/or non-copper-containing materials.

The aftertreatment system 120 may also include one or more catalyst member(s) (e.g., conversion catalyst member, selective catalytic reduction (SCR) catalyst member, catalyst metals, etc.) shown as a first catalyst member 178 and a second catalyst member 180. As shown in FIGS. 1-3, the first catalyst member 178 is positioned downstream of the first dosing module 150 and upstream of the second dosing module 152 and the second catalyst member 180 is positioned downstream of the first dosing module 150 and the second dosing module 152. The first catalyst member 178 and/or the second catalyst member 180 is/are configured to cause decomposition of components of the exhaust gas using the treatment fluid (e.g., via catalytic reactions, etc.). The first catalyst member 178 and/or the second catalyst member 180 may include a catalyst housing that is coupled to the exhaust conduit system 105. In some embodiments, the catalyst housing is integrally formed with the exhaust conduit system 105. The first catalyst member 178 and/or the second catalyst member 180 may include an catalyst substrate that is coupled to the catalyst housing. In some embodiments, the catalyst substrate is integrally formed with the upstream catalyst housing.

The first catalyst member 178 and/or the second catalyst member 180 may receive the exhaust from the exhaust conduit system 105. The exhaust flows through the catalyst substrate and reacts with the catalyst substrate so as to cause the exhaust to undergo the processes of evaporation, thermolysis, and/or hydrolysis to form non-NOx emissions within the first catalyst member 178 and/or the second catalyst member 180. In some embodiments, the exhaust and the treatment fluid within the exhaust react with the catalyst substrate. In this way the first catalyst member 178 and/or the second catalyst member 180 is/are configured to assist the reduction of NOx emissions by accelerating a NOx reduction process between the reductant and the NOx of the exhaust gas into diatomic nitrogen, water, and/or carbon dioxide.

Now referring to FIG. 4, a perspective view of another portion of an example aftertreatment system 120 is shown. The inlet conduit 106 includes an inlet end 108 and an outlet end 109. The inlet end 108 is centered on a first axis and the outlet end 109 is centered on a second axis displaced from the first axis. The first dosing module 150 is disposed at the outlet end 109 such that the second axis extends between the first dosing module 150 and the first axis. The curvature of the inlet conduit 106 between the first axis and the second axis causes the exhaust to flow into the spray of the treatment fluid from the first dosing module 150. The offset advantageously enhances mixing compared to a straight conduit.

As described above, the first dosing module 150 and/or the second dosing module 152 may be positioned along the exhaust conduit system 105. Similarly the valve assembly 160 may be positioned within the exhaust conduit system 105 relative to the first dosing module 150. As shown in FIG. 4, the valve assembly 160 is positioned within the introduction conduit 107. However, it should be understood that the valve assembly 160 may be positioned at other locations within the exhaust conduit system 105, as described above.

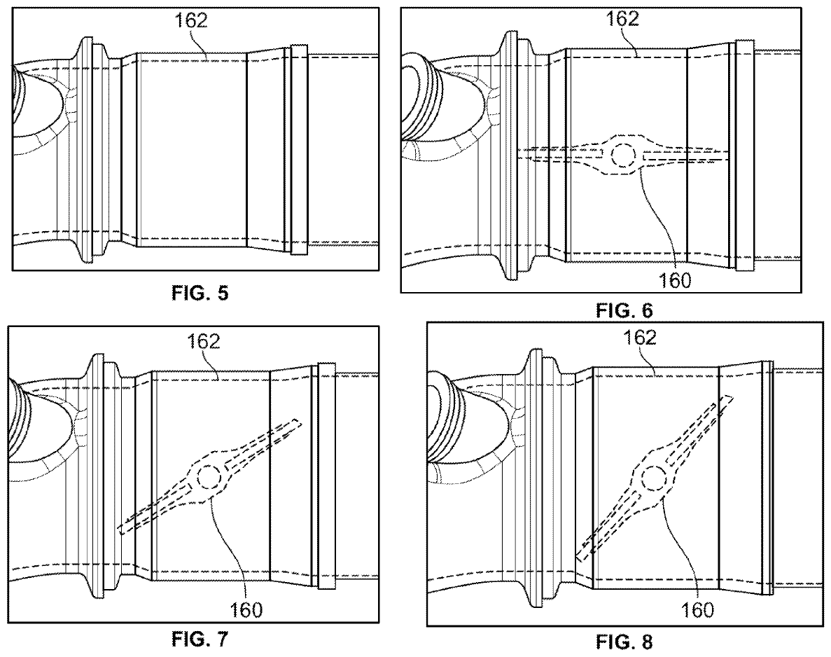

Now referring to FIGS. 5-8, various views of an example aftertreatment system 120 are shown. In FIG. 5, a side view of introduction conduit 107 of the aftertreatment system 120 is shown. The introduction conduit 107 is shown without the valve assembly 160. In FIG. 6, a side view of introduction conduit 107 of the aftertreatment system 120 is shown. The introduction conduit 107 is shown with the valve assembly 160 in a first position of a plurality of positions. The first position may allow the exhaust to flow through the exhaust conduit system 105 at a first flow rate. In FIG. 7, a side view of introduction conduit 107 of the aftertreatment system 120 is shown. The introduction conduit 107 is shown with the valve assembly 160 in a second position of the plurality of positions. The second position may allow the exhaust to flow through the exhaust conduit system 105 at a second flow rate. In FIG. 8, a side view of introduction conduit 107 of the aftertreatment system 120 is shown. The introduction conduit 107 is shown with the valve assembly 160 in a third position of a plurality of positions. The third position may allow the exhaust to flow through the exhaust conduit system 105 at a third flow rate. The first flow rate is greater than the second flow rate and greater than the third flow rate. The second flow rate is less than the first flow rate and greater than the third flow rate. The third flow rate is less than the first flow rate and less than the second flow rate. It should be understood that the positions of the valve assembly 160 shown in FIGS. 6-8 are examples only, and the valve assembly 160 may be actuatable between a plurality of positions between a fully open position and a fully closed position. Each of the plurality of positions may correspond to a flow rate of the exhaust flowing through the exhaust conduit system 105.

### III. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, reductant, an air-reductant mixture, exhaust, may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

1. An internal combustion engine system comprising:
a turbomachine;
an exhaust conduit coupled to the turbomachine and turbomachine and configured to receive exhaust from the turbomachine, the exhaust conduit having a conduit internal diameter;
a first dosing module positioned along the exhaust conduit and configured to selectively dose reductant into the exhaust within the exhaust conduit; and
a valve assembly positioned within the exhaust conduit, the valve assembly being selectively actuatable between at least (i) a first position that allows the exhaust to flow at a first flow rate through the exhaust conduit, and (ii) a second position that allows the exhaust to flow at a second flow rate through the exhaust conduit;
wherein a first valve assembly distance between the valve assembly and the first dosing module is less than or equal to 3 times the conduit internal diameter.

2. The internal combustion engine system of claim 1, further comprising a second dosing module positioned along the exhaust conduit and downstream of the first dosing module, the second dosing module configured to selectively dose reductant into the exhaust within the exhaust conduit.

3. The internal combustion engine system of claim 2, further comprising:
a controller operatively coupled to the first dosing module, and the valve assembly, the controller configured to:
selectively operate the first dosing module to dose the reductant into the exhaust within the exhaust conduit; and
selectively actuate the valve assembly so as to move between the first position and the second position.

4. The internal combustion engine system of claim 3, wherein the controller is further configured to selectively operate the second dosing module to dose the reductant into the exhaust within the exhaust conduit.

5. The internal combustion engine system of claim 2, wherein the valve assembly is positioned upstream of the second dosing module.

6. The internal combustion engine system of claim 2, wherein a distance between the valve assembly and the second dosing module is between 0.5 and 10 meters.

7. The internal combustion engine system of claim 2, wherein a distance between the first dosing module and the second dosing module is between 0.5 and 10 meters.

8. The internal combustion engine system of claim 1, wherein:
the turbomachine is a turbocharger comprising a turbine wheel having an exducer having an exducer diameter; and
a distance between the first dosing module and the turbomachine is between 0 and 10 exducer diameters.

9. The internal combustion engine system of claim 1, wherein a distance between the valve assembly and the first dosing module is between 2 and 10 conduit internal diameters.

10. The internal combustion engine system of claim 1, wherein a ratio of (i) a first distance between the first dosing module and the turbomachine, and (ii) a second distance between the valve assembly and the first dosing module, is less than or equal to 10 conduit internal diameters.

11. The internal combustion engine system of claim 1, wherein:
the exhaust conduit has an inner diameter; and
the valve assembly comprises:
a valve actuator, and
a valve plate, the valve plate having a valve diameter that is equal to the inner diameter.

12. The internal combustion engine system of claim 11, wherein the valve plate comprises one or more flow vanes.

13. The internal combustion engine system of claim 11, wherein:
the valve plate has a surface finish that is between at least one of:
0.010 micrometers (μm) average surface roughness (Ra) and 15 μm Ra, inclusive; and
0.1 μm Ra and 125 μm RA, inclusive; and
the valve plate comprising a stainless steel material.

14. An internal combustion engine system comprising:
a turbomachine;
an exhaust conduit coupled to the turbomachine and configured to receive exhaust from the turbomachine;
a first dosing module positioned along the exhaust conduit and configured to selectively dose reductant into the exhaust within the exhaust conduit; and
a valve assembly positioned within the exhaust conduit downstream of the turbomachine and upstream of the first dosing module, the valve assembly being selectively actuatable between at least (i) a first position that allows the exhaust to flow at a first flow rate through the exhaust conduit, and (ii) a second position that allows the exhaust to flow at a second flow rate through the exhaust conduit.

15. The internal combustion engine system of claim 14, further comprising a second dosing module positioned along the exhaust conduit and downstream of the first dosing module, the second dosing module configured to selectively dose reductant into the exhaust within the exhaust conduit.

16. The internal combustion engine system of claim 15, further comprising:
a controller operatively coupled to the first dosing module, and the valve assembly, the controller configured to:
selectively operate the first dosing module to dose the reductant into the exhaust within the exhaust conduit;
selectively actuate the valve assembly so as to move between the first position and the second position; and
selectively operate the second dosing module to dose the reductant into the exhaust within the exhaust conduit.

17. The internal combustion engine of claim 14, wherein:
the exhaust conduit has an inner diameter; and
the valve assembly comprises:
a valve actuator, and
a valve plate, the valve plate having a valve diameter that is equal to the inner diameter, the valve plate comprising one or more flow vanes.

18. The internal combustion engine system of claim 14, wherein the turbomachine is a turbocharger operatively coupled to a compressor such that the turbocharger causes the compressor to compress an intake gas of the internal combustion engine system.

19. The internal combustion engine system of claim 15, wherein the turbomachine is a power turbine operatively coupled to at least one of an electric machine such that the power turbine causes the electric machine to generate electricity or a driveshaft such that the power turbine provides mechanical power to the driveshaft.

20. An internal combustion engine system comprising:
a turbomachine;
an exhaust conduit coupled to the turbomachine and configured to receive exhaust from the turbomachine;
a first dosing module positioned along the exhaust conduit and configured to selectively dose reductant into the exhaust within the exhaust conduit; and
a valve assembly positioned within the exhaust conduit downstream of the first dosing module, the valve assembly being selectively actuatable between at least (i) a first position that allows the exhaust to flow at a first flow rate through the exhaust conduit, and (ii) a second position that allows the exhaust to flow at a second flow rate through the exhaust conduit.

21. The internal combustion engine system of claim 20, further comprising:
a controller operatively coupled to the first dosing module, and the valve assembly, the controller configured to:
selectively operate the first dosing module to dose the reductant into the exhaust within the exhaust conduit; and
selectively actuate the valve assembly so as to move between the first position and the second position.

22. The internal combustion engine system of claim 21, further comprising a second dosing module positioned along the exhaust conduit and downstream of the first dosing module, the second dosing module configured to selectively dose reductant into the exhaust within the exhaust conduit.

23. The internal combustion engine system of claim 22, wherein the controller is further configured to selectively operate the second dosing module to dose the reductant into the exhaust within the exhaust conduit.
